(19) United States
(12) Patent Application Publication
(10) Pub. No.: US 2026/0003702 A1
(43) Pub. Date: Jan. 1, 2026

(54) INTELLIGENT SELECTION METHOD, AND INFORMATION SYSTEM PLATFORM USING THE SAME

(71) Applicant: Quanta Computer Inc., Taoyuan City (TW)

(72) Inventors: Chi-Chang CHEN, Taoyuan City (TW); Chen-Chung LEE, Taoyuan City (TW); Yen-Bo TSENG, Taoyuan City (TW); Chia-Hung LIN, Taoyuan City (TW); Kun-Ping KUO, Taoyuan City (TW)

(21) Appl. No.: 18/901,255

(22) Filed: Sep. 30, 2024

(30) Foreign Application Priority Data
Jun. 28, 2024 (TW) 113124249

(51) Int. Cl. G06F 9/54; G06F 9/50

(52) U.S. Cl. CPC G06F 9/547; G06F 9/5038

(57) ABSTRACT

An intelligent selection method is provided to determine the communication mode when the first service calls the second service in the information system platform to execute a service with multiple tasks. The aforementioned method includes calculating the unfinished workload of the first service's previous call to the second service, and calculating the task-completion time of the most recent work completed by the second service. The aforementioned method includes selecting whether to use the first strategy or the second strategy to communicate when the first service calls the second service, according to the unfinished workload and the completion time. Finally, the aforementioned method includes notifying the first service of the selection result.

### CROSS REFERENCE TO RELATED APPLICATIONS

This application claims priority of Taiwan Patent Application No. 113124249, filed on Jun. 28, 2024, the entirety of which is incorporated by reference herein.

### BACKGROUND OF THE INVENTION

### Field of the Invention

The present invention relates to the application of information system platforms, and, in particular, to a method for intelligently selecting communication modes between multiple services in an information system platform, and an information system platform using the same.

### Description of the Related Art

An information system platform is composed of various functional services (that is, application programs, or module functions). When a task needs to be completed by a platform, the platform will connect in series with the required functional services to complete the task. The serial communication modes used between these services are mainly divided into two categories: (1) Representational State Transfer Application Programming Interface (Restful API, for short), and (2) Message queue. The characteristics and applicable scenarios of these two modes are briefly listed below.

### Two Categories (Two Modes):

### (1) Restful API:

Features: Simpler, faster processing, synchronous calls.
Applicable situations: small amount of work per unit time, and short-term work.

### (2) Message Queue:

Features: More complex, slower processing, asynchronous calls.
Applicable situations: A large amount of work per unit time, and long-term work.

Usually, in designing architectural of an information system platform, the serial communication mode between every two services will first be determined based on the characteristics and working conditions. Referring to FIG. 1, the architecture of the traditional information system platform 10 is shown. There are 10 components in the information system platform, including service A, service B, service C and service D, which communicate in series. The symbols Task1, Task2 and Task3 in FIG. 1 represent tasks. In this example, it is assumed that the tasks Task1 and Task2 processed between the service A and the service B, and the task Task2 processed between the service B and the service C, are small amount of work per unit time and short-term work, so the designers of information system platforms usually use the Restful API 11 communication mode between service A and service B and between service B and service C respectively. In addition, it is assumed that the task Task3 processed between service C and service D needs to be further processed by the task task2, which is a large amount of work per unit time and a long-term work. Therefore, the designers of the information system platform usually use the communication mode of Message Queue 12 between the service C and the service D.

However, which serial communication modes between information system platform services is more appropriate cannot be well decided at the design stage. For example, if Restful API is designed as the communication mode, when certain tasks require a long time to be executed, the tasks may not be executed successfully because the Restful API's timeout period is exceeded. In addition, if Message Queue is designed as the communication mode, when the workload is not large, or when some work can be completed in a short time, speed performance will be lost due to the queue characteristics of queuing execution.

Based on above descriptions, at present, in the design stage of the platform, it may be necessary to predetermine which mode is used to communicate between services. However, without real-time dynamic selection mechanism, it is impossible to use the most suitable communication mode dynamically to complete the task.

### BRIEF SUMMARY OF THE INVENTION

Accordingly, in order to solve the aforementioned problems, the present invention provides a mechanism that can dynamically select the most appropriate communication modes among multiple services of an information system platform.

One embodiment of the present invention provides an intelligent selection method, which can be used for communication in an information system platform when a first service calls a second service to perform a service with multiple tasks. The intelligent selection method includes the following steps. The method includes calculating the number of unfinished tasks that the first service previously called upon the second service to perform. The method includes calculating the task completion time of the most recent task completed by the second service. Based on the number of unfinished tasks and the completion time, the method includes determining to use a first mode or a second mode to perform the communication between the first service and the second service when the first service is currently calling upon the second service, and then notifying the first service of the selection result.

Another embodiment of the present invention provides an information system platform, including a first service, a second service, and an intelligent selection unit for determining the mode of communication when the first service calls upon the second service to perform a service with multiple tasks. The intelligent selection unit performs the following steps. The intelligent selection unit performs the step of calculating the number of unfinished tasks that the first service previously called the second service to perform, and calculating the task-completion time of the most recent task completed by the second service; and based on the number of unfinished tasks and the completion time, determining to use a first mode or a second mode to perform the communication between the first service and the second service when the first service is currently calling upon the second service, and then notifying the first service of the selection result.

### BRIEF DESCRIPTION OF THE DRAWINGS

The present invention can be more fully understood by reading the subsequent detailed description and examples with references made to the accompanying drawings, wherein:

FIG. 1 shows the architecture of a conventional information system platform 10.

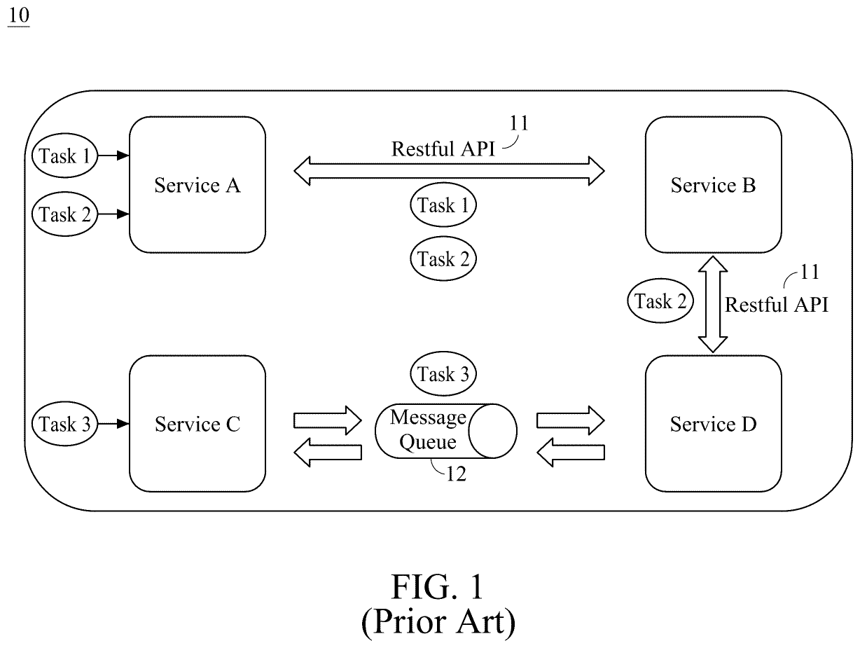

FIG. 2 shows the system architecture of an information system platform 20 according to one embodiment of the present invention.

FIG. 3 shows a flow chart of an intelligent selection method 30 according to another embodiment of the present invention.

FIG. 4 shows a conceptual diagram of system operation corresponding to the first service and the second service when the smart selection method of the present invention is applied to an information system platform.

### DETAILED DESCRIPTION OF THE INVENTION

In order to make the aforementioned objects, features and advantages of the present invention more obvious and easy to understand, the following is a detailed description of the preferred embodiments and the accompanying drawings.

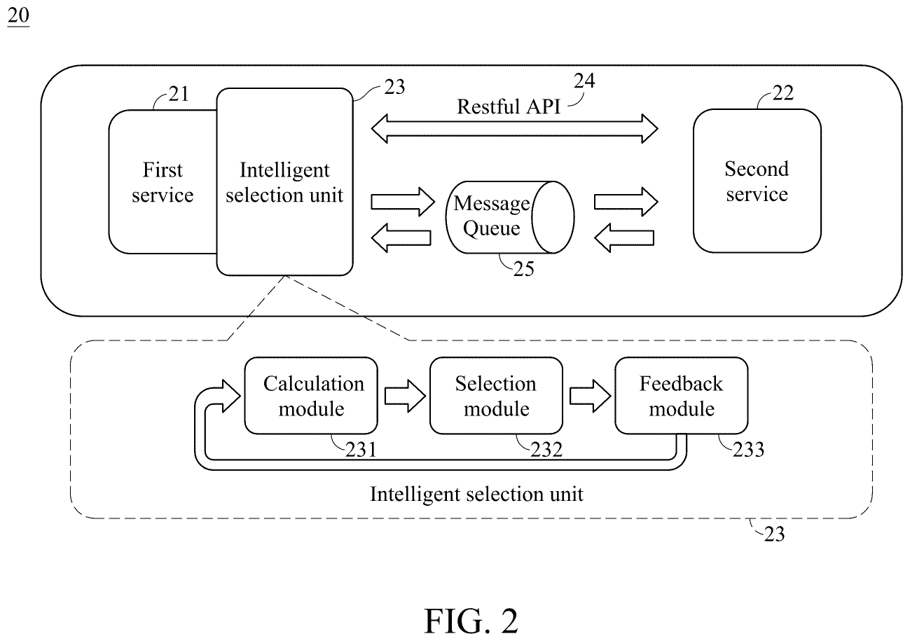

FIG. 2 shows the system architecture of an information system platform 20 according to one embodiment of the present invention. In FIG. 2, the information system platform 20 includes a first service 21, a second service 22, and an intelligent selection unit 23. Communication between the first service 21 and the second service 22 can be carried out through the Restful API 24 (which is an example of the first mode of the present invention) or the Message Queue 25 (which is an example of the second mode of the present invention). The main point of the present invention is that the intelligent selection unit 23 is configured to perform dynamic and real-time selection to determines the Restful API 24 or the Message Queue 25 to be used for communication between the first service 21 and the second service 22.

The information system platform 20 of the present invention is, for example, a computer system, electronic device, or server and other electronic equipment with a processor or controller. Programs can be loaded and executed by the processor or controller to achieve the desired functions. The first service 21 and the second service 22 are, for example, application programs or modules that can complete specific functions after the application program is executed by the processor or controller. There may be one or more physical channels (not shown) between the first service 21 and the second service 22. Through the intelligent selection unit 23, the communication between the first service 21 and the second service 22 can follow the Restful API 24 or the Message Queue 25. The intelligent selection unit 23, for example, loads and executes a program through a processor or controller to achieve the required functions.

The intelligent selection unit 23 may include: a calculation module 231, a selection module 232, and a feedback module 233. The calculation module 231 calculates the number of unfinished tasks and determines whether it exceeds a task-number threshold, and calculates a completion time. The selection module 232 selects the communication mode (the first mode or the second mode of the present invention) based on the result of the calculation module 231. The feedback module 233 re-performs or retry the task between the first service 21 and the second service 22 according to the selected communication mode, and updates the record. The calculation module 231, selection module 232, and feedback module 233, for example, are functional modules formed after a program is loaded and executed by a processor or controller. In addition, the intelligent selection unit 23 can be a single module to perform all operations and functions of the calculation module 231, selection module 232, and feedback module 233. In addition, in some embodiments, the intelligent selection module 23, calculation module 231, selection module 232, and feedback module 233 can also be implemented by Application Special Integrated Circuits (ASIC) or Field Programmable Logic Gate Arrays (FPGA) and other hardware.

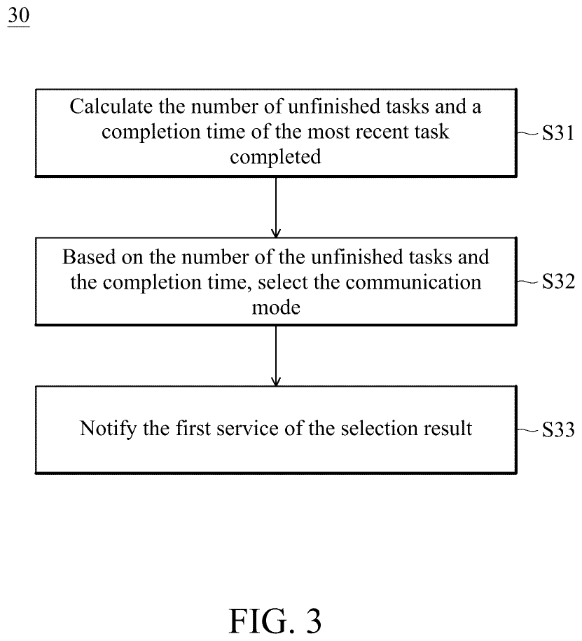

FIG. 3 shows a flow chart of an intelligent selection method 30 of another embodiment of the present invention. The intelligent selection method of the present invention corresponds to the operations and functions of the intelligent selection unit 23 and is used to determine the communication mode when the first service 21 in the information system platform 20 calls the second service 22 to execute a service with multiple tasks. That is, intelligent selection method is configured to select the first mode (Restful API 24) or the second mode (Message Queue 25) for communication of the first and second services dynamically and in real time.

In FIG. 3, according to the intelligent selection method 30 of the present invention, first calculate the number of unfinished tasks that the first service previously called the second service to perform, and a completion time of the most recent task completed by the second service (step: S31). Then, in step S32, based on the number of unfinished tasks and the completion time, determine that when the first service 21 is currently calling upon the second service 22, it is selected to use the Restful API 24 (the first mode) or the Message Queue 25 (the second mode) to perform the communication between the first service 21 and the second service 22. Then, the first service 21 is notified of the selection result (step S33).

Here, the number of unfinished tasks indicates the number of task that the first service 21 has sent to the second service 22 in the previous time, but that has not yet been completed by the second service 22.

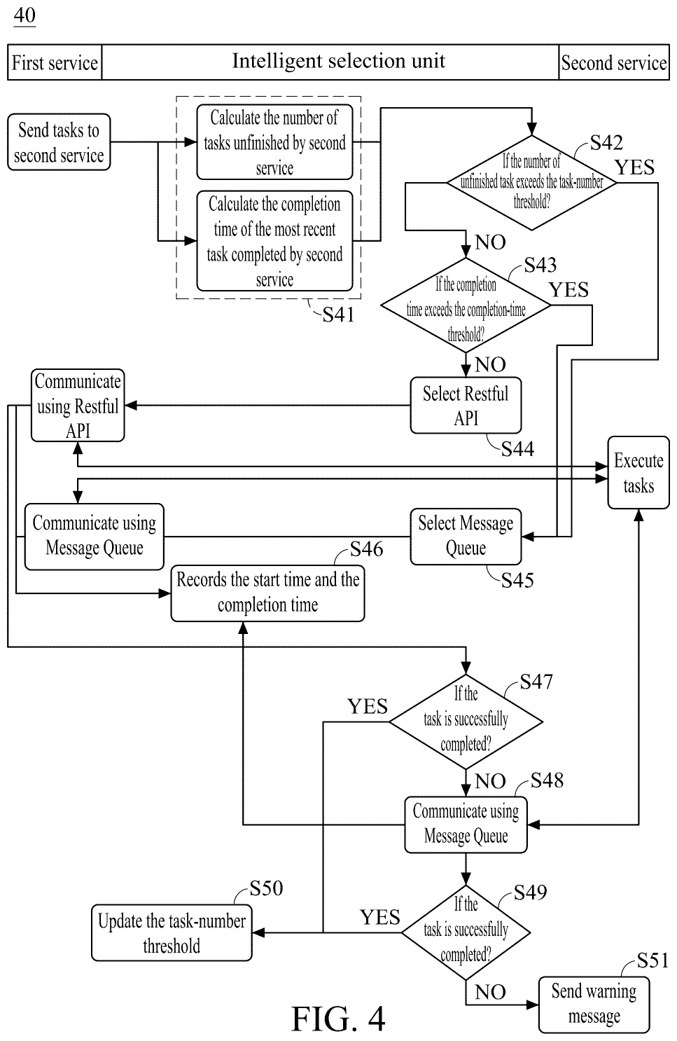

FIG. 4 shows a conceptual system-operation diagram 40 of the intelligent selection method 30 (performed by the intelligent selection unit 23) corresponding to the first service 21 and the second service 22 when the intelligent selection method 30 of the present invention is applied to the information system platform 20. Below, the intelligent selection method 30 in FIG. 3 will be described in detail with reference to FIG. 4 and FIG. 2.

Referring to FIG. 4, after the first service 21 transfers the task to the second service 22, the intelligent selection unit 23 calculates the time after the first service 21 called the second service 22 (that is, transferred the work to the second service 22), the number of unfinished tasks Count_W that has not yet been completed by the second service 22, and the completion time Time_W of the latest work completed by the second service 22 (step S41). Next, determine whether the number of unfinished tasks Count_W exceeds the task-number threshold TH_W (step S42), and whether the completion time Time_W exceeds the completion-time threshold TH_T (step S43).

When the number of unfinished tasks Count_W does not exceed the task-number threshold TH_W (step S42: No), and the completion time Time_W does not exceed the completion-time threshold TH_T (step S43: No), the Restful API mode is selected (step S44).

When the number of unfinished tasks Count_W does not exceed the task-number threshold TH_W (step S42: No), but the completion time Time_W has exceeded the completion-time threshold TH_T (step S43: yes), the Message Queue mode is selected (step S45). In addition, when the number of unfinished tasks Count_W exceeds the task-number threshold TH_W (step 42: Yes), the Message Queuing mode is selected (step S45).

Then, the first service 21 uses the Rest API 24 or the Message Queue 25 to communicate with the second service 22 according to the selection result of the intelligent selection unit 23. Moreover, the first service 21 communicates at work with the second service 22 through the Rest API 24 or the message queue 25.

For any one of the multiple tasks, the intelligent selection unit 23, from the first service 21, receives a “starting time” when the task is performed by the second service 22, from the second service 22 through the first service 21, receiving the “completion time” of the task, and further records the starting time and the completion time (step S46). The intelligent selection unit 23 can further use the completion time and the starting time to calculate the “completion time of the task” to update the completion time Time_W.

In addition, after the first service 21 uses the Rest API 24 or the Message Queue 25 to communicate with the second service 22 according to the selection result of the intelligent selection unit 23, the intelligent selection unit 23 further receives the information from the first service 21 to determine whether the task performed by the second service 22 in response to the calling upon of the first service 21 is successfully completed (step S47). If the determination is successful (step S47: Yes), increase the task-number threshold Count_W. Here, for example, it can be increased by 5% to 15%, preferably by 10%. Next, the task-number threshold is updated (step S50).

In some embodiments, the intelligent selection unit 23 can further determine whether the communication mode is Restful API during operations. In this way, if the communication mode is the Restful API and the intelligent selection unit 23 determines that the task is not completed successfully (step S47: No), then the communication mode is changed to the Message Queue to re-execute the task performed by the second service 22 in response to calling upon of the first service (step S48).

Here, changing the communication mode to the Message Queue and performing the task again, the success rate of task execution can be improved, and the stability of the information system platform 20 can be improved. On the other hand, because under the Restful API communication mode, the unfinished task will fail to be executed at the moment, but the Message Queue mode can be used to execute successfully, which means that the workload executed by the second service through the Restful API should be below the number of unfinished tasks (that is, the second service 22 fails to afford the number of unfinished task), so the task-number threshold TH_W can be designed to be the number of unfinished tasks Count_W at this time.

In addition, after re-performing the task in the Message queue mode (step S48), the intelligent selection unit 23 determines whether the task is successfully completed (step S49); if it is determined to be successful (step S49: yes), the task-number threshold is reduced. Here, for example, it can be reduced by 5% to 15%, preferably by 10%. Afterwards, the task-number threshold is updated (step S50). If the intelligent selection unit 23 determines that the task is not completed successfully (step S49: No), a warning message is sent (step S51).

In addition, when re-preforming the task in the Message Queue mode (step S48), the intelligent selection unit 23 receives, from the first service 21, the starting time of the re-performed task, receiving, and receives, from the second service 22, the completion time of the re-performed task, to update the completion time (step S46).

In the aforementioned embodiment, the initial value of the task-number threshold Count_W can be any initial value, and can be determined based on the experience value after the accumulated actual operations. Through the method of the present invention, the task-number threshold suitable for each service can be gradually and adaptively adjusted. In addition, the initial value of the completion-time threshold TH_W is the timeout setting value of the Restful API (Representational State Transfer Application Programming Interface).

In order to make the features of the present invention easier to understand, various examples are listed below. First, two thresholds are given: the task-number threshold TH_W, and the completion-time threshold TH_T. Set the initial values of the two thresholds. For example, the task-number threshold TH_W is set to 1000 (can be any initial value), and the completion-time threshold TH_T is set to the restful API's timeout setting value, for example, 60 seconds.

### [Scenario 1]

When the first service 21 transfers tasks to the second service 22, the calculation process is as follows.
(1) Obtain the number of unfinished tasks Count_W which have been sent to the second service 22, for example, 100 (tasks). Calculate the completion time Time_W of the most resent task sent from the first service to the second service 22, for example, 20 seconds.
(2) According to the following decision rule:

If Count_W(100) > TH_W (1000)
Select Message Queue
else if Time_W (20 seconds) > TH_T (60 seconds)
Select Message Queue
else
Select Restful API.

(3) Based on the logical decision result, the Restful API communication mode is selected.

Provided that the task is executed successfully (step S47), the task-number threshold TH_W is increased by 10% (step S50), and the task-number TH_W is updated to TH_W×(1+10%)=1100. Next, the completion time Time_W of the most recent task is updated to, for example, 30 seconds (step S46).

### [Scenario 2]

Continuing from scenario 1, when the first service 21 wants to send task to the second service 22, the calculation process is as follows.
(1) Calculate the number of unfinished tasks Count_W which have been sent to the second service 22 to execute, for example, 800 (tasks). Calculate the completion time Time_W of the most resent task sent from the first service to the second service 22, for example, 30 seconds.
(2) According to the following decision rule:

If Count_W (800) > TH_W (1100)
Select Message Queue
else if Time_W (30 seconds) > TH_T (60 seconds)
Select Message Queue
else
Select Restful API.

(3) Based on the logical decision result, the Restful API communication mode is selected.

Provided that the task execution fails this time, perform this task again using the Message Queue communication mode (step S48). If the retry execution is successful (step S49), then the task-number threshold TH_W is reduced (step S50). Because the task-number threshold TH_W is 1100 which is greater than the number of unfinished tasks Count_W (800) at this time, the task-number threshold TH_W is updated to become the number of unfinished tasks Count_W=800. The latest completion time Time_W is updated to 65 seconds here.

### [Scenario 3]

Continuing from scenario 2, when the first service 21 wants to send task to the second service 22, the calculation process is as follows.
(1) Calculate the number of unfinished tasks Count_W, for example, 700. Calculate the completion time Time_W of the most resent task sent from the first service 21 to the second service 22, for example, here 30 seconds.
(2) According to the following decision rule:

If Count_W (700) > TH_W (800)
Select Message Queue
else if Time_W (65 seconds) > TH_T (60 seconds)
Select Message Queue
else
Select Restful API.

(3) Based on the logical decision result, the Message Queue communication mode is selected. The latest completion time Time_W is updated to 65 seconds, here.

### [Scenario 4]

Continuing from scenario 3, when the first service 21 wants to send task to the second service 22, the calculation process is as follows.
(1) Calculate the number of unfinished tasks Count_W, for example, 100. Calculate the completion time Time_W of the most resent task sent from the first service 21 to the second service 22, for example, here 40 seconds.
(2) According to the following decision rule:

If Count_W (100) > TH_W (800)
Select Message Queue
else if Time_W (40 seconds) > TH_T (60 seconds)
Select Message Queue
else
Select Restful API.

(3) Based on the logical decision result, the Restful API communication mode is selected.

Provided that the task is executed successfully (step S47), the task-number threshold TH_W is increased by 10%, and the task-number threshold TH_W is updated to TH_W×(1+10%) to become 880 (step S50). The latest completion time Time_W is updated to 30 seconds (step S46).

Another embodiment of the present invention is a computer-readable recording medium that stores a program. When the computer loads the program and executes it, it can complete all operations and functions of the aforementioned intelligent selection method. The present invention has the following advantages and effects.

(I) There is no need to decide which communication mode to use between all services during the design stage of the information system platform.

(II) It can dynamically determine the most appropriate communication mode between services based on real-time actual conditions during execution.

(III) When the information system platform's services are busy and exceed the tolerable workload, selecting the Message Queue communication mode can reduce the task execution failure rate and pursue stability.

(IV) When the information system platform service is not busy, selecting the Restful API communication mode can improve processing efficiency.

(V) The platform can intelligently adjust to achieve a dynamic balance of high platform stability and optimal performance, based on real-time conditions.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An intelligent selection method for an information system platform to determine the mode of communication when a first service calls a second service to perform a service with multiple tasks, comprising the steps of:
calculating a number of unfinished tasks that the first service previously called upon the second service to perform, and calculating a task-completion time of the most recent task completed by the second service; and
based on the number of unfinished tasks and the completion time, determining to use a first mode or a second mode to perform the communication between the first service and the second service when the first service is currently calling upon the second service, and then notifying the first service of the selection result.

2. The intelligent selection method as claimed in claim 1; wherein the step of determining to use the first mode or the second mode based on the number of unfinished tasks and the completion time further comprises the following steps:
determining to use the first mode when the number of unfinished tasks does not exceed a task-number threshold and the completion time does not exceed a completion-time threshold;
determining to use the second mode when the number of unfinished tasks does not exceed the task-number threshold but the completion time exceeds the completion-time threshold; and
determining to use the second mode when the number of unfinished tasks exceeds the task-number threshold.

3. The intelligent selection method as claimed in claim 1, further including, for any one of the multiple tasks, receiving a starting time and the completion time to perform said task using the second service.

4. The intelligent selection method as claimed in claim 3, further using the completion time and the starting time to calculate and update the task-completion time.

5. The intelligent selection method as claimed in claim 1, further including receiving information from the first service and determining whether the task that the first service called upon the second service to perform, is successfully completed;
when it is determined to be successful, increasing the task-number threshold; and
when it is determined to be unsuccessful, and the first mode is used, changing to use the second mode and re-performing the task that the first service has called upon the second service to perform.

6. The intelligent selection method as claimed in claim 5, wherein after re-performing the task in the second mode, determining whether the task was successfully completed;
when it is determined to be successful, reducing the task-number threshold.

7. The intelligent selection method as claimed in claim 6, wherein after re-performing the task in the second mode, receiving the starting time of re-performing the task from the first service and receiving the completion time of the re-performed task from the second service to update the task-completion time.

8. The intelligent selection method as claimed in claim 1, wherein the initial value of the task-number threshold is arbitrary and depends on the accumulated experience value after actual operation; and
the initial value of the completion-time threshold is the timeout setting value of Representational State Transfer Application Programming Interface (Restful API).

9. The intelligent selection method as claimed in claim 5, wherein the task-number threshold is increased or reduced by 5% to 15% of the task-number threshold, preferably is 10%.

10. The intelligent selection method as claimed in claim 6, wherein the task-number threshold is increased or reduced by 5% to 15% of the task-number threshold, preferably is 10%.

11. An information system platform comprising:
a first service and a second service; and
an intelligent selection unit for determining the mode of communication when the first service calls the second service to perform a service with multiple tasks;
wherein the intelligent selection unit performs the steps of:
calculating the number of unfinished tasks that the first service previously called upon the second service to perform, and calculating a task-completion time of the most recent task completed by the second service; and
based on the number of unfinished tasks and the completion time, determining to use a first mode or a second mode to perform the communication between the first service and the second service when the first service is currently calling upon the second service, and then notifying the first service of the selection result.
